(19) United States
(12) Patent Application Publication
(10) Pub. No.: US 2001/0002928 A1
(43) Pub. Date: Jun. 7, 2001

(54) Wireless athletic training communicator

(76) Inventor: Christopher D. Cummins, Santa Ana, CA (US)

Correspondence Address: Michael J. Moffatt, Esq., Price And Gess, 2100 S.E. Main Street, Suite 250, Irvine, CA, 92614-6238, US

(21) Appl. No.: 09/761,015

(22) Filed: Jan. 15, 2001

Related U.S. Application Data
(63) Continuation-in-part of application No. 09/216,603, filed on Dec. 17, 1998.
Application No. 09/216,603 is a continuation-in-part of application No. 09/532,207, filed on Mar. 22, 2000.

(51) Int. Cl. H04M 1/00; H04M 9/00

(52) U.S. Cl. 379/430

(57) ABSTRACT

A waterproof device for communicating by radio to a swimmer or other user includes a radio frequency receiver supplying a signal to a pressure transducer, a hollow, flexible sound conducting tube connected to an output of the transducer, an ear hook for attachment to an ear of a user of the apparatus, the ear hook being shaped to retain and conduct the tube from the receiver to the ear; and an ear piece shaped to fit in the ear of the user and having an opening therein for conducting sound provided via the tube to the ear.

### CROSS REFERENCE TO RELATED APPLICATIONS

This application is a continuation-in-part of application Ser. No. 09/532,207, filed Mar. 23, 2000 for Coach Communicator.

### BACKGROUND OF THE INVENTION

1. Field of the Invention

The subject invention relates generally to communication devices and more particularly to a receiver and speaker system for communicating sound signals from a remote signal source to a user such as a swimmer or other athlete.

2. Description of Related Art

While a number of devices have been proposed to provide communication via radio to swimmers, the resulting devices have been cumbersome and complex and otherwise exhibit disadvantages which have prevented any widespread adoption and use.

### SUMMARY OF THE INVENTION

According to the invention, a simplified communication device for supplying sound via radio frequency transmission to a swimmer or other user is provided. The device features an apparatus that provides simple and effective sound generation and supply of the sound to a user's ear. In a first embodiment, sound supply to the user is achieved using a sound-conducting tube supplied with a sound signal by a pressure transducer, together with an improved and effective ear piece unit. In a second embodiment, sound supplied to the user is achieved using a small waterproof speaker unit that fits into an earpiece of the unit. In this embodiment, the waterproof speaker is operable connected to a receiver worn on the athlete for receiving wireless transmission from a local transmitter.

While the present invention is especially well suited for athletic activities such as swimming and running, there are many other applications which are projected for the device. Models for different activities, such as a “Fun” model, and “sport” model, and a “pro” model will reflect subtle style changes to accommodate the particular user. Further, the present invention has industrial applications whereby an individual can communicate to a group of people, such as employees in a shop, using the present invention.

Various objects, features and advantages of the present invention will become readily apparent to those skilled in the art from the following detailed description, wherein is shown and described only the preferred embodiment of the invention, simply by way of illustration of the best mode contemplated of carrying out the invention.

### BRIEF DESCRIPTION OF THE DRAWINGS

The objects and many advantages of the present invention will become apparent by reference to the following description taken in conjunction with the attached drawings, wherein like reference numerals indicate like parts throughout the figures, and wherein:

FIG. 1 is a perspective view of a preferred embodiment of the present invention;

FIG. 2 is a top view of the preferred embodiment of FIG. 1;

FIG. 3 is an elevated perspective view of an earpiece of the present invention;

FIG. 4 is a cross-sectional view of the ear piece of FIG. 3 along with a speaker cover designed to mate with the ear piece; and

FIG. 5 is a perspective view of a second embodiment of the present invention.

### DETAILED DESCRIPTION OF A PREFERRED EMBODIMENT

The following description is provided to enable any person skilled in the art to make and use the invention and sets forth the best modes contemplated by the inventor of caring out his invention. Various modifications, however, will remain readily apparent to those skilled in the art since the general principles of the present invention have been defined herein specifically to provide a wireless athletic training communication device and system.

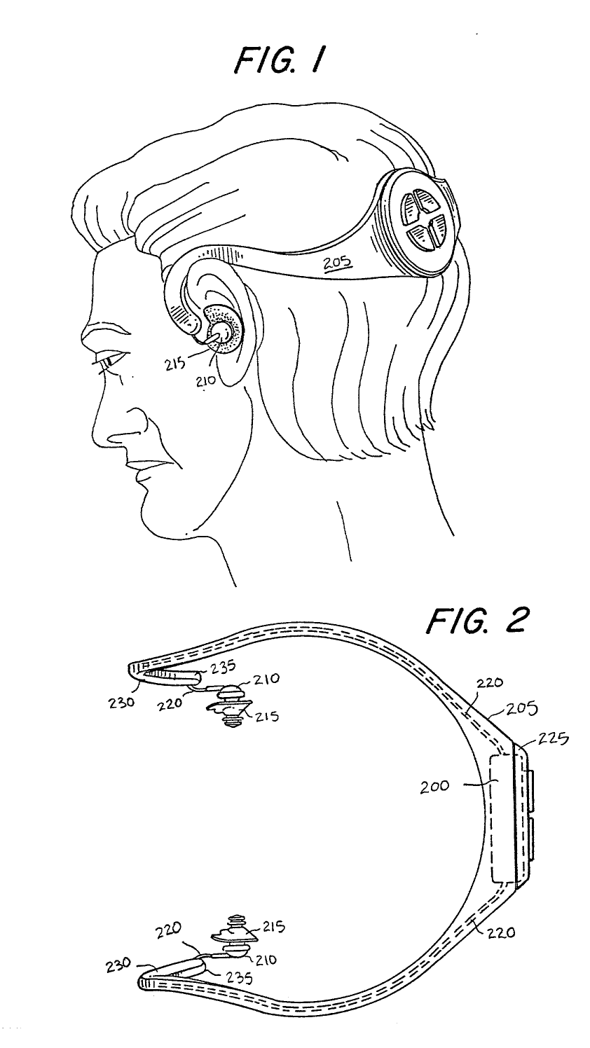

FIG. 1 illustrates a first preferred embodiment of the present invention. Worn on the head of an athlete such as for example a swimmer, the device includes a wireless receiver, a headset from mounting the receiver, and a pair of speakers connected to the receiver. The speakers are adapted to engage with an earpiece located in the athlete's ear to communicate sound from the speaker to the inner ear. FIG. 2 shows a top view of the present invention including the wireless receiver and connecting wire shown in phantom. The wireless receiver is housed in a headset unit which is adapted to conform to the athlete's head. The headset includes a compartment for housing the wireless receiver and the wires which connect thereto. As shown in FIG. 2, the profile of the headset has semi-circular shape terminating in a spiral portion fitting over the athlete's ear. The headset is a unitary construction molded with a hard resin or plastic such as krayton. Within head set at the compartment, the wireless speaker is secured and the connecting wires traverse the length of the head set to the distill ends. Through orifice at each end of the distill ends of the headset, the wires lead to a miniature waterproof speaker as shown in FIG. 2. Although, the waterproof speakers could be rigidly mounted to the ends of the headset, in a preferred embodiment there is some play due to the length of the connecting wires to provide more comfort and flexibility to a variety of head sizes.

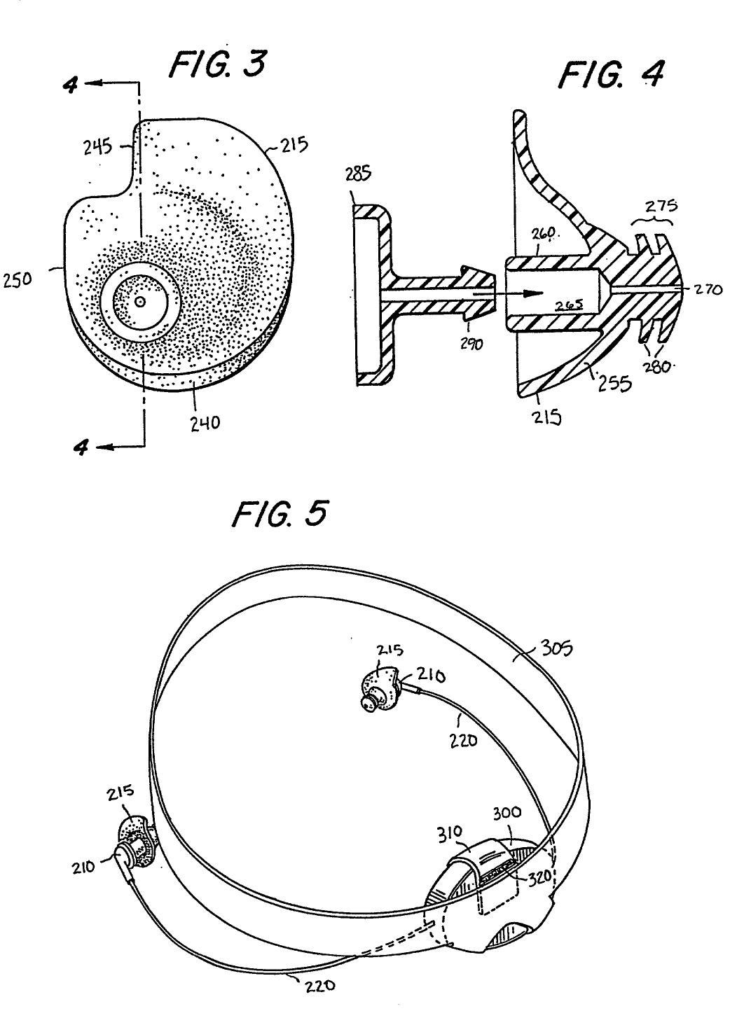

In FIGS. 3 and 4 the earpiece of the present invention as well as the cover plate for the speaker is shown. FIG. 3 illustrates a perspective view of the conical shaped earpiece of the present invention. The earpiece has an external flange extending around the pinna with a side adapted to fit against the helix and a side adapted to fit against tragus. The earpiece also has a portion having a cross section which progressively narrows so as to fit against the cavum cuncha. Within the flange of the earpiece is externally horizontally disposed projection having an interior cylindrical chamber. The interior cylindrical chamber leads to a smaller cylindrical chamber passing completely through the earpiece. The plug portion of the earpiece includes first and second flexible concentric flanges. Each of these flanges has a generally circular perimeter and each is swept back slightly towards the outside of the ear canal. This particular flange structure provides ready insertion and sealing of the inner ear as well adaptability to various size ear canals. The earpiece may preferably be molded as a single piece plastic component of for example krayton or other suitable plastic material.

With further reference to FIG. 4 the normally smooth speaker cap has been replaced with a speaker cap that includes a nipple projecting from the center of the speaker cap. As shown, the speaker may then be inserted directly into the horizontal projection of the earpiece thereby introducing sound waves directly through the earpiece to the inner ear. The head of the speaker cap nipple is slightly larger than the diameter of the earpiece resulting in a tight, but releasable fit. Waterproof speakers, such as those manufactured by Martec, Inc. of Towsend, Md., are preferably used for swimming applications. As one can imagine, there numerous variations on the mating of the speaker with the ear piece including for example, adhesives, snap fitting, and alike, and the invention should not be deemed to be limited to the specific mating as shown.

A second preferred embodiment of the present invention is shown in FIG. 5, in which the wireless receiver is held by a flexible band which circumscribes the athlete's head. This headband is preferably made of neoprene material or similar material and includes a strap for securing the wireless receiver mounted with hooks and loops pairing. In this embodiment the wires emanating from the wireless receiver and their connected speakers are not housed in headset but merely extend along the athlete's head. The speakers are then inserted into the earpieces which are located in the athlete's ear and operates in a similar manner to the description above.

The operation of the just described system will now be described in more detail. When an athlete is outfitted with the wireless receiver and speakers connected to the earpiece, a local transmitter can deliver wireless electronic sound signals to the receiver. The transmitter may be connected to a microphone via a jack such that a coach can send instructions to for example, a swimmer swimming laps in a pool. Alternatively, the transmitter can be hooked up to a radio or CD player such that the swimmer can enjoy music while exercising. In a preferred embodiment a transmitter can include both a line for transmitting music and a microphone line for a coach to speak over the music and communicate instructions to the athlete. If multiple athletes are using a receiver tuned to the same frequency, a single transmitter can be used to send instructions to a team of athletes in a like manner.

Those skilled in the art will further appreciate that various adaptations and modifications of the just-described preferred embodiments can be configured without departing from the scope and spirit of the invention. Therefore, it is to be understood that within the scope of the appended claims, the invention may be practiced other than as specifically described herein.

What is claimed is:

1. An apparatus comprising:
a radio frequency receiver;
a hollow, flexible sound conducting tube;
an ear hook for attachment to an ear of a user of the apparatus, said ear hook being shaped to retain and conduct said tube from said receiver to said ear; and
an earpiece shaped to fit in the ear of the user and having an opening therein for conducting sound provided via said tube to the ear.

2. The apparatus of claim 1 wherein said earpiece is further shaped to seal water out of the ear.

3. The apparatus of claim 2 wherein the earpiece has an external horizontally disposed projection providing an interior passageway of a first cross-section leading to an interior passageway of a second cross-section, said second cross-section being smaller than first cross-section.

4. The apparatus of claim 3 further including an intermediate passageway component connecting said tube and said external projection.

5. The apparatus of claim 3 wherein said first and second cross-sections are sized to permit sound transmission but to preclude water transmission.

6. The apparatus of claim 3 wherein said ear piece further comprises first and second circular flanges disposed adjacent one another and concentrically about said second passageway.

7. The apparatus of claim 1 wherein said radio frequency receiver is mounted in a waterproof housing which receives said hollow tube in watertight fashion.

8. The apparatus of claim 7 wherein said radio frequency receiver supplies a signal to a pressure transducer device connected to said hollow tube.

9. An apparatus comprising:
an ear piece shaped to fit in the ear of a user, said ear piece having an external horizontally disposed projection providing an interior passageway of a first cross-section leading to an interior passageway of a second cross-section, said second cross-section being smaller than first cross-section, said first and second cross-sections being sized to permit sound transmission but to preclude water transmission, said ear piece further having first and second circular flanges disposed adjacent one another and positioned concentrically about said second passageway.

10. An apparatus comprising:
means for receiving a radio frequency signal and converting said signal to a sound signal;
an ear hook means for attachment to an ear of a user of the apparatus, said ear hook means being shaped to retain and conduct said tube from said receiver to said ear;
an ear piece shaped to fit in the ear of the user and having an opening therein for conducting sound to the ear; and
means receiving said sound signal and cooperating with said ear hook for conducting said sound signal to the opening in said ear piece.

11. The apparatus of claim 10 wherein said earpiece is further shaped to seal water out of the ear.

12. The apparatus of claim 10 wherein the earpiece has an external horizontally disposed projection providing an interior passageway of a first cross-section leading to an interior passageway of a second cross-section, said second cross-section being smaller than first cross-section.

13. The apparatus of claim 12 wherein said means for conducting comprises a hollow tube and an intermediate passageway component sealably connecting said tube and said external projection.

14. The apparatus of claim 13 wherein said first and second cross-sections are sized to permit sound transmission but to preclude water transmission.

15. The apparatus of claim 13 wherein said ear piece further comprises first and second circular flanges disposed adjacent one another and concentrically about said second passageway.

16. The apparatus of claim 13 wherein said radio frequency receiver is mounted in a waterproof housing which receives said hollow tube in watertight fashion.

17. The apparatus of claim 13 wherein said means for receiving comprises a radio frequency receiver supplying a signal to a pressure transducer device, the pressure transducer device being connected to said hollow tube.

18. The apparatus of claim 1 wherein said ear hook includes a portion of partially open cross section for receiving said hollow tube and a second portion sized to receive said hollow tube in male-female fashion, said second portion further being shaped to insert into said ear piece.

19. The apparatus of claim 10 wherein said ear hook includes a portion of partially open cross section for receiving said hollow tube and a second portion sized to receive said hollow tube in male-female fashion, said second portion further being shaped to insert into said ear piece.

20. The apparatus of claim 18 wherein said ear hook forms part of a headset.

21. The apparatus of claim 20 wherein said headset includes a solid end portion from which said ear hook extends.
